(19) United States
(12) Patent Application Publication
(10) Pub. No.: US 2007/0207738 A1
(43) Pub. Date: Sep. 6, 2007

(54) Apparatus and method for inferring the amount of interference in a wireless communication system

(75) Inventors: Satoshi Nakayama, Tokyo (JP); Satoru Yamano, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/711,818

(22) Filed: Feb. 28, 2007

(30) Foreign Application Priority Data
Mar. 1, 2006 (JP) 2006-054617

(51) Int. Cl. H04B 15/00

(52) U.S. Cl. 455/63.1; 370/445

(57) ABSTRACT

A wait-time acquisition unit measures a wait time before transmission of data in an exposed terminal, and an interference-amount inferring unit infers the amount of interference in the exposed terminal based on the wait-time information. A channel-utilization calculation unit calculates an amount of channel utilization based on the inferred amount of interference. A call admission controller controls call admission based on the amount of channel utilization that is considered with the amount of interference in the exposed terminal.

### BACKGROUND OF THE INVENTION

1. Field of the Invention

The present invention relates to an apparatus and a method for inferring the amount of interference in a wireless communication system, and more particularly to an apparatus and a method for inferring the amount of interference caused by other terminals used in a wireless communication.

The present invention also relates to a communication system and a control method thereof, and more particularly, to a wireless communication system and a control method thereof which controls the wireless communication system based on an inferred amount of interference.

2. Description of the Related Art

Wireless communication systems, such as a wireless LAN (local area network) system, are prevailing in these days. In a wireless LAN system, a radio link is established between an access point and a terminal for transmitting and receiving data such as in the form of packets. In a wireless communication system, since a radio signal is used for the data transmission and reception, it is difficult to completely eliminate interference between radio signals. If interference occurs, there arises a problem that communication quality decreases. For example, if a BSS (basic Service Set) which performs a real time data transmission and another BSS which operates in the same frequency channel exist in an area to cause overlapping of these BSSs, the packet transmitted from the another BSS causes interference, and the QoS (quality of service) of the real time transmission is deteriorated.

A non-patent document (Tomoya Tandai, Tomoko Adachi, and Kiyoshi Toshimitsu, “A study of interference detection method guaranteeing Quality of Service of real-time data transmission in Wireless Local Area Network”, IEICE Technical Committee (RCS2004-128), August, 2004, pp. 49-54) describes a technique for detecting an interference wave in a wireless communication system to prevent deterioration of the communication quality. In this document, a terminal measures the received power during receiving data, and stores the received power as received power data. When the terminal detects a receiving error after the data reception, the terminal analyzes the stored received power data, and judges whether or not an error is generated by the influence of the interference wave based on the change of the received power.

FIG. 11 shows the situation of occurring of the interference. If an interfering terminal 303 transmits data in the channel same as the channel of an interfered terminal 302 when an access point 301 transmits data to the interfered terminal 302, the interfered terminal 302 observes the change of the received power caused by superposition of radio waves. If the interfered terminal 302 finds such a power change, the interfered terminal 302 judges that there exists an interference wave. Alternatively, if a high received power is observed even after the data reception, the interfered terminal 302 judges that the interference wave exists. If the interfered terminal 302 detects the interfering wave, the interfered terminal 302 switches the communication channel thereof, to thereby continue the communication in another channel having no interference.

FIG. 12 exemplifies the state of communication in a wireless LAN system. In a channel-conflict-type communication, such as the wireless LAN system CSMA/CA (Carrier Sense Multiple Access with Collision Avoidance), a terminal waits for data transmission therefrom if another terminal which belongs to the same access point is transmitting data to the access point. For example, when a terminal-A 401 detects that another terminal-C 403 transmits data to an access points 411, the terminal-A 401 waits for data transmission, and transmits data to the access points 411 at the timing that the another terminal-C 403 does not transmit data.

For example, the case that the access point-P 411 and another access points 412 use the same communication channel and the terminal-A 401 intends to transmit data to the access point-P 411 will be considered. In this case, when a terminal-B 402 transmits data to the access point-Q 412, since the terminal-A 401 exists in the communication range of the terminal-B 402, it is detected by the terminal-A 401 that the communication channel is being used. Therefore, even when any terminal does not transmit data to the belonging access point-P 411, the data transmission is awaited, and there arises a problem that the throughput of the data transmission and reception is lowered. Such an interference phenomenon is called “exposed-terminal problem” in this text. The interfering terminal-B 402 is called “exposing terminal”, and the interfered terminal-A 401 is called “exposed terminal” in this text. The range of channel which cannot be used because of the interference causing the transmission to await is defined herein as the amount of interference.

In a CSMA/CA communication, the “exposed terminal” waits for data transmission while the “exposing terminal” is transmitting data. Thus, the “exposed terminal” and the “exposing terminal” do not transmit data simultaneously. In the above publication, it is premised that these two terminals transmit data simultaneously. In the technique described in the publication, the interference with the “exposing terminal” cannot be detected on the side of the “exposed terminal”. Further, if the cell is designed in the communication system so that the communication channel frequencies of the adjacent cells are not superposed with each other, the interference itself does not occur due to use of the different communication channels in the adjacent cells. However, in a wireless LAN system such as IEEE802.11b, the number of communication channels which can be used simultaneously without interference is small, such as four in Japan, and three in overseas. In such a communication system, the cell disposition that all the adjacent cells use different communication channels is substantially impossible, and it is not possible to completely exclude the interference.

### SUMMARY OF THE INVENTION

It is an object of the present invention to provide an apparatus for inferring the amount of interference, which is capable of eliminating the problems of the above-mentioned conventional technique, and detecting the interference caused by the exposing terminal to infer the amount of interference.

Further, it is another object of the present invention to provide a wireless communication system and a control method of the wireless communication system, which are capable of maintaining communication quality of the “exposed terminal” even when an exposing terminal exists in the vicinity of the exposed terminal.

The present invention provides an interference-amount inferring device including: an inferring unit for inferring an amount of interference caused in an exposed wireless communication terminal by an exposing wireless communication terminal, the inferring unit collecting wait-time information representing a degree of wait before transmission of intended data in the exposed wireless communication terminal and inferring said amount of interference based on the collected wait-time information.

The present invention also provides a method for inferring an amount of interference including: collecting wait-time information representing a degree of wait before transmission of intended data in an exposed wireless communication terminal; and inferring based on the collected wait-time information an amount of interference caused in the exposed wireless communication terminal by an exposing wireless communication terminal.

In accordance with the device and method of the present invention for inferring the amount of interference, the amount of interference inferred by the configuration of the present invention corresponds to the degree of wait in the exposed terminal before transmission of intended data by the exposed terminal. Thus, the inferred amount of interference may be used for preventing the communication quality of the exposed terminal.

The wait-time information may include the channel-acquisition delay time and/or a number of back-off stop times before transmission of the intended data. The channel acquisition delay time is measured from the time instant at which the exposed terminal starts for channel acquisition. The number of back-off stop times is counted as the number of times for which the exposed terminal enters a wait mode before transmission of the intended data.

The present invention also provides a wireless communication system including: an interference-amount inferring device for inferring an amount of interference caused in an exposed wireless communication terminal by an exposing wireless communication terminal; and a communication controller for preventing deterioration of a communication quality in the wireless communication system based on the inferred amount of interference.

The present invention also provides a method for controlling a wireless communication system, including: inferring an amount of interference caused in an exposed wireless communication terminal by an exposing wireless communication terminal; and preventing deterioration of a communication quality in the wireless communication system based on the inferred amount of interference.

In accordance with the communication system and the method is for controlling the communication system of the present invention, the control of the exposed terminal involved with an interference caused by an exposing terminal prevents the communication quality of the exposed terminal from being degraded to thereby maintain a superior communication quality.

The above and other objects, features and advantages of the present invention will be more apparent from the following description, referring to the accompanying drawings.

### BRIEF DESCRIPTION OF THE DRAWINGS

FIG. 1 is a block diagram showing the configuration of a communication controller including an inference-amount inferring apparatus according to a first embodiment of the present invention;

FIG. 2 is a flowchart showing the procedure of the communication controller shown in FIG. 1; communication controller shown in FIG. 1;

FIG. 3 is a block diagram showing the configuration of a wireless communication system in which an inference-amount inferring apparatus is installed;

FIG. 4 is a graph showing the relationship between the amount of traffic and channel acquisition delay;

FIG. 5 is a block diagram showing the configuration of a communication controller including an inference-amount inferring apparatus according to a second embodiment of the present invention;

FIG. 6 is a flowchart showing the procedure of a communication controller according to the second embodiment;

FIG. 7 is a block diagram showing the configuration of a wireless communication system in which an inference-amount inferring apparatus according to the second embodiment is installed;

FIG. 8 is a block diagram showing the configuration of a communication controller including an inference-amount inferring apparatus according to a third embodiment of the present invention;

FIG. 9 is a flowchart showing the procedure of the communication controller according to the third embodiment;

FIG. 10 is a block diagram showing the configuration of a wireless communication system in which an inference-amount inferring apparatus according to the third embodiment is installed;

FIG. 11 is a block diagram showing the situation of occurring of an interference in a wireless communication system; and

FIG. 12 is a schematic view showing the state of communication in wireless LAN system.

### DETAILED DESCRIPTION OF THE PREFERRED EMBODIMENTS

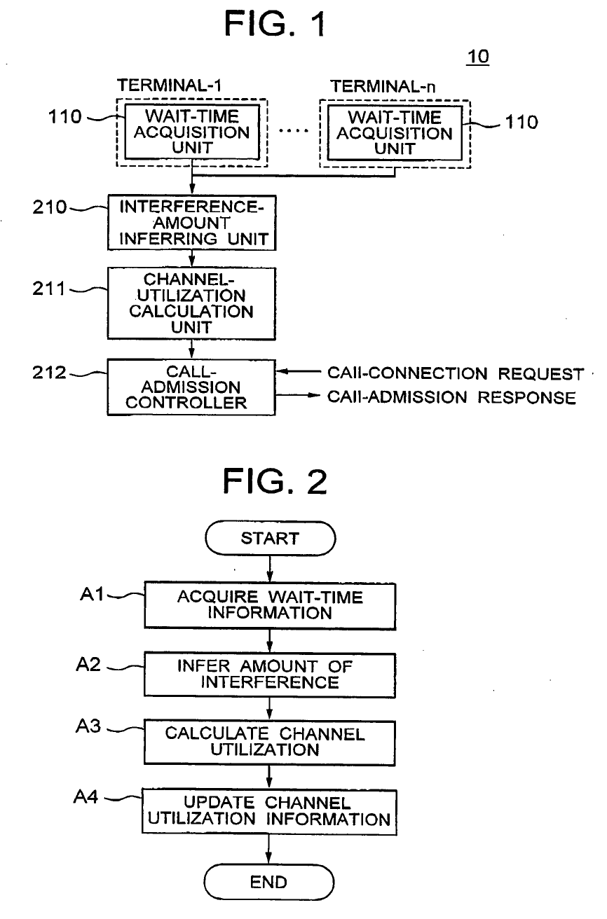

Embodiments of the present invention will be described in detail hereinafter with reference to the accompanying drawings. FIG. 1 shows the configuration of a communication controller including an inference-amount inferring unit according to a first embodiment of the present invention. The communication controller 10 has a wait-time acquisition unit 110 and the interference-amount inferring unit 210 which configures an interference-amount inferring apparatus according to the present invention, a channel-utilization calculation unit 211 and a call admission controller 212. The interference-amount inferring unit 210, the channel-utilization calculation unit 211 and the call admission controller 212 are provided at the access point for communicating with a plurality of terminals. The wait-time acquisition unit 110 is provided at each terminal for connecting to the access point.

The wait-time acquisition unit 110 obtains wait-time information showing the degree for which the terminal is forced to await transmission of the intended data. Examples of the wait-time information include a channel acquisition delay showing a delay time in acquisition of the transmission channel, and a number of times of back-off stop. More specifically, the channel acquisition delay shows a time length from the time instant of starting trying to acquire the channel for an intended packet transmission to the time instant of actually starting the packet transmission process. The number of times of the back-off stop shows the number of times of entering a wait mode due to detection of a transmission by another terminal during the channel acquisition, such as encountered in the contention period of wireless LAN system.

The interference-amount inferring unit 210 collects wait-time information measured by the wait-time acquisition unit 110, statistically processes the collected wait-time information, and thereby infers the degree of the inference to the data transmission by the exposing terminal. The interference-amount inferring unit 210 stores the corresponding relationship between the wait-time information and the channel utilization volume, infers the amount of interference based on the corresponding relationship and the wait-time information measured by the wait-time acquisition unit 110, and outputs the inference amount information showing the degree of the exposition and the specific terminal being exposed.

The channel-utilization calculation unit 211 grasps the channel used by each terminal, calculates the radio channel necessary for maintaining the communication quality of the terminal based on the channel utilization and the interference amount information inferred by the interference-amount inferring unit 210, and outputs the channel utilization information. The call admission controller 212 determines admission of a new call at the time of receiving a new call-connection request from the terminal. The judgment of admission is performed based on the presence or absence of the free space for receiving a new call based on the channel utilization information output from the channel-utilization calculation unit 211.

FIG. 2 shows the procedure of the communication controller 10 when the channel utilization information is updated. The wait-time acquisition unit 110 of each terminal acquires the wait-time information each time the terminal transmits own data (step A1). The interference-amount inferring unit 210 acquires the wait-time information output from the wait-time acquisition unit 110, and infers the amount of interference (step A2). In step A2, the interference-amount inferring unit 210 acquires the wait-time information from each terminal, and infers the degree of influence that each terminal receives from the exposing terminal. The channel-utilization calculation unit 211 calculates the channel utilization based on the amount of interference that is inferred by the interference-amount inferring unit 210 and the channel information of each terminal (step A3), and updates the channel utilization information (step A4).

The communication controller 10 iterates the steps A1 to A4 of FIG. 2, and updates the channel utilization information by the latest information. If there is a new call-connection request from a terminal, the call admission controller 212 controls the call admission based on the channel utilization information updated in step A4.

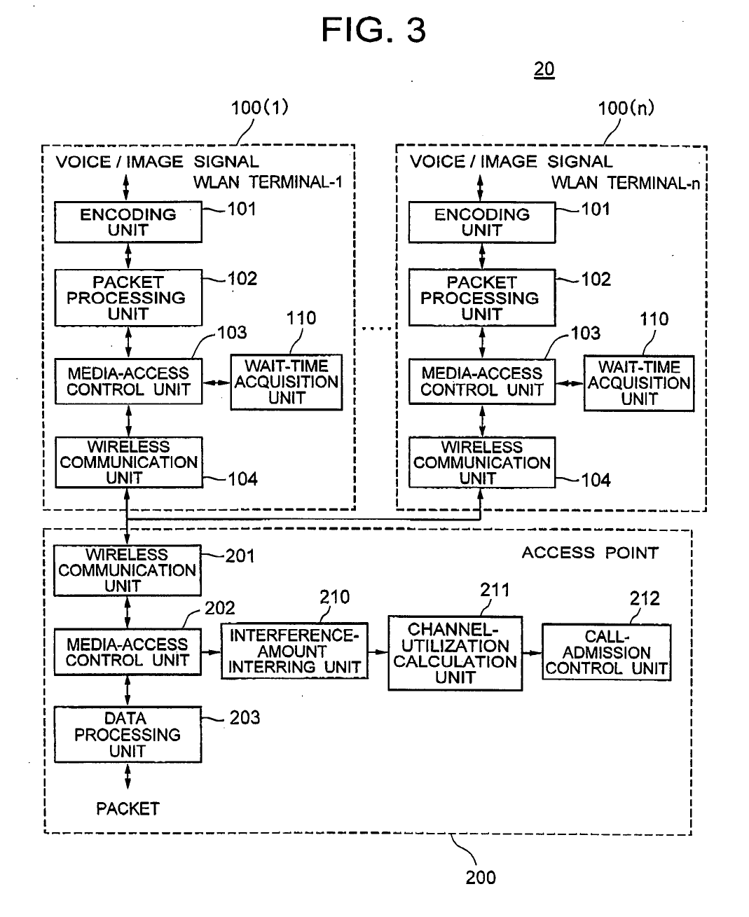

FIG. 3 shows the configuration of a wireless communication system in which the inference-amount inferring unit of the present embodiment is installed. In this example, the wireless communication system 20 has a plurality of WLAN (Wireless LAN) terminals 100(1) to (n) where n is a natural number, and an access point 200. Each WLAN terminal 100 has an encoding unit 101, a packet processing unit 102, a media-access control unit 103, a wireless communication unit 104, and a wait-time acquisition unit 110. The access point 200 has a wireless communication unit 201, a media-access control unit 202, a data processing unit 203, the interference-amount inferring unit 210, a channel-utilization calculation unit 211, and a call admission controller 212.

The encoding unit 101 encodes the data, such as voice signal and image signal, received therein, and outputs the encoded data. The packet processing unit 102 packetizes the encoded data received therein, and outputs the packet data. When a packet to be transmitted is input from the packet processing unit 102, the media-access control unit 103 issues an instruction to start measuring of the wait-time information by the wait-time acquisition unit 110, and at the same time tries for channel acquisition. When a channel is acquired and a packet is transmitted, the media-access control unit 103 acquires wait-time information measured by the wait-time acquisition unit 110, and delivers a transmission packet including the acquired wait-time information to the wireless communication unit 104. The wireless communication unit 104 converts the received packet to a radio wave signal for transmission.

After the wireless communication unit 201 of the access point 200 receives a radio wave signal from any WLAN terminal 100, the wireless communication unit 201 delivers the received packet to the media-access control unit 202. The media-access control unit 202 delivers the received packet data to the data processing unit 203 that decodes the received data. In this case, the wait-time information is read from the received packet, and the read wait-time information is delivered to the interference-amount inferring unit 210. The interference-amount inferring unit 210 infers the inference amount of the terminal which transmitted the data based on the wait-time information.

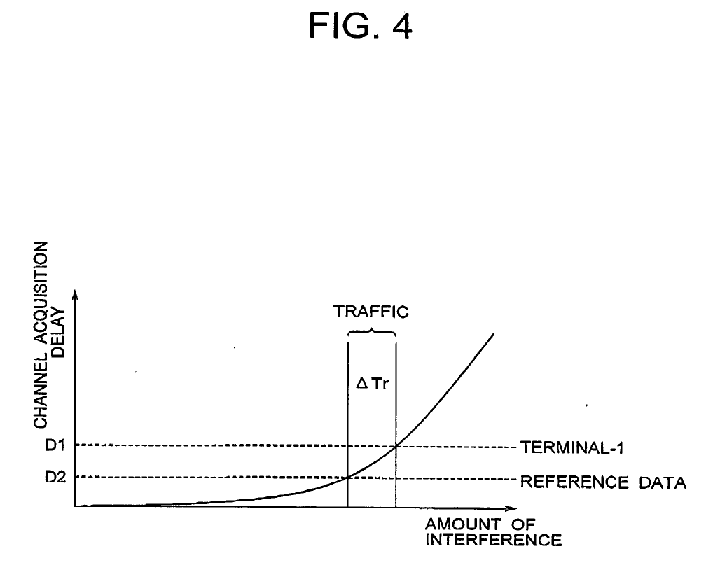

Since the terminal receiving the interference from the exposing terminal outputs the wait-time information different in the characteristic from the wait-time information of the terminal which does not receive the interference, the interference-amount inferring unit 210 infers the amount of interference utilizing the difference of the characteristic. FIG. 4 shows the relationship between the traffic and the channel acquisition delay. In general, the channel-conflict-type wireless LAN system has a tendency of increase in the channel acquisition delay if the network traffic of the packet quantity that is sent to a radio channel increases. Assuming that the channel acquisition opportunity of each WLAN terminal 100 is equal, and if the traffic volume is constant, it will be expected that all the WLAN terminals 100 have an equal channel acquisition delay. Thus, if the channel acquisition delay of a specific WLAN terminal 100 is larger than the channel acquisition delay of the other WLAN terminals 100, the specific WLAN terminal 100 is considered to be affected by an exposing terminal.

It is assumed here that the channel acquisition delay D1 is received as the wait-time information from a specific WLAN terminal, for example, WLAN terminal 100(1). The interference-amount inferring unit 210 compares this channel acquisition delay D1 against an expected value D2 (reference data) of the channel acquisition delay in the terminal not affected by an exposing terminal, and infers the amount of interference. As the reference data D2, the channel acquisition delay received from another WLAN terminal 100 that is not affected by the exposing terminal can be used. The interference-amount inferring unit 210 uses the relationship shown in FIG. 4 and infers that a difference ΔTr of the channel utilization volume, i.e., traffic, corresponding to the channel acquisition delay D1 received from the WLAN terminal 100(1) and the channel utilization volume corresponding to the reference data is the amount of interference by the exposing terminal. Further, the interference-amount inferring unit 210 may use the relationship shown in FIG. 4 and calculate the expected value D2 of the channel acquisition delay from the channel utilization volume of the current network, taking the expected value as the reference data. This is equivalent to the assumption that the difference between the channel utilization volume corresponding to the channel acquisition delay D1 and the current channel utilization volume is the amount of interference.

The channel-utilization calculation unit 211 calculates the channel utilization or channel vacation of the radio channel based on the current channel utilization and the amount of interference inferred by the interference-amount inferring unit 210. The channel utilization or channel vacation here is the combination of the amount of interference and the actual channel utilization, and this is the value that the influence by which the “exposed terminal” is caused to wait for data transmission is taken into account. For example, if the actual current channel vacation is 3 Mb/s and the amount of interference of the WLAN terminal 100(1) inferred by the interference-amount inferring unit 210 is 1 Mb/s, the channel vacation is set at 2 Mb/s. When the call admission controller 212 receives a new call-connection request from another WLAN terminal 100, it decides whether not this call-connection request is to be admitted by referring to the channel utilization calculated by the channel-utilization calculation unit 211. The call admission controller 212 does not admit the connection of the another WLAN terminal 100, if the channel vacation considered for the amount of interference is narrower than the requested channel. On the other hand, if the channel vacation considered for the amount of interference is larger than the requested channel, the call admission controller 212 admits the connection of the WLAN terminal 100.

As a comparison example, the case is considered in which the amount of interference of the “exposed terminal” is not considered at the time of receiving a call-admission request. It is assumed here that the WLAN terminal 100(n), for example, specifies a 2.5 Mb/s channel and transmits a call-admission request. In this case, if the actual channel vacation is 3 Mb/s, then the call admission controller 212 returns a response of call admission from the WLAN terminal 100(n). In this case, if the channel vacation volume in consideration of the amount of interference of the exposing terminal is 2 Mb/s, it is equivalent to the channel vacation=2 Mb/s for the WLAN terminal 100(1) receiving the interference of the exposing terminal. This state is equivalent to the state in which an insufficient channel vacation occurred due to the WLAN terminal 100(n) starting use of a 2.5 Mb/s channel. Therefore, the channel acquisition opportunity of the WALN terminal 100(1) is reduced by taking into consideration connection by the WLAN terminal 100(n), whereby a desired channel cannot be acquired by the WLAN terminal 100(1), and the communication quality of the WLAN terminal 100(1) is deteriorated.

In this embodiment, the interference-amount inferring unit 210 statistically processes the wait-time information, and thereby, infers the amount of interference by the exposing terminal. The wait-time information shows the value reflecting the deterioration of the communication quality caused by the exposed-terminal problem. It is possible to infer by using such information the amount of interference by the exposing terminal, which cannot be heretofore inferred. Further, in this embodiment, the connection of the terminal requesting the call admission is permitted by the call admission controller 212 using the inferred the amount of interference in a range not exceeding the channel utilization in consideration of the amount of interference by the exposing terminal. Thus, even in the circumstances that the exposed-terminal problem is occurring, the channel access opportunity of the “exposed terminal” can be maintained. In this manner, the environment that the “exposed terminal” can sufficiently frequently send the packet can be maintained, and the deterioration of the communication quality of the “exposed terminal” can be prevented.

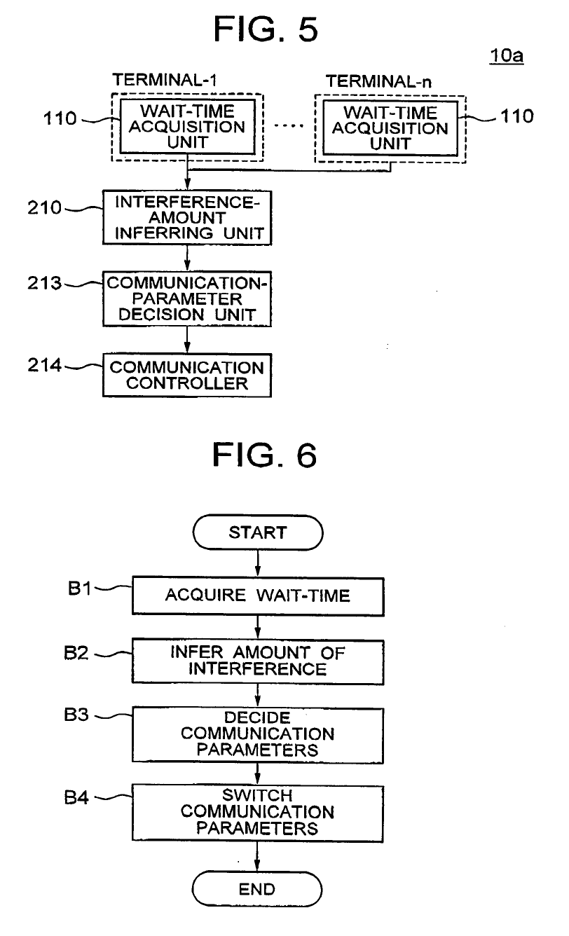

FIG. 5 shows the configuration of a communication controller including an inference-amount inferring unit according to a second embodiment of the present invention. A communication controller 10a of this embodiment includes a communication-parameter decision unit 213 and a communication controller 214, as the means for preventing the communication quality deterioration. The communication-parameter decision unit 213 decides the communication parameter so as to enhance the communication efficiency of the terminal receiving the influence by the exposing terminal based on the amount of interference inferred by the interference-amount inferring unit 210. Examples of the communication parameters include the type of a media access control scheme, a transmission priority, and the like. The communication controller 214 performs communication using the communication parameters decided by the communication-parameter decision unit 213.

FIG. 6 shows an example of the procedure of the communication controller 10a. The wait-time acquisition unit 110 acquires wait-time information in a procedure similar to step A1 of FIG. 2 (step B1). Further, the interference-amount inferring unit 210 infers the amount of interference in a procedure similar to step A2 (step B2). The communication-parameter decision unit 213 determines whether or not the “exposed terminal” exists based on the amount of interference inferred in step B2, and decides communication parameters, with which the terminal can efficiently communicate, based on an exposed state, i.e., the state of occurring of an interference (step B3). The communication controller 214 switches the current communication parameters to the communication parameters decided in step B3, and continues the communication (step B4).

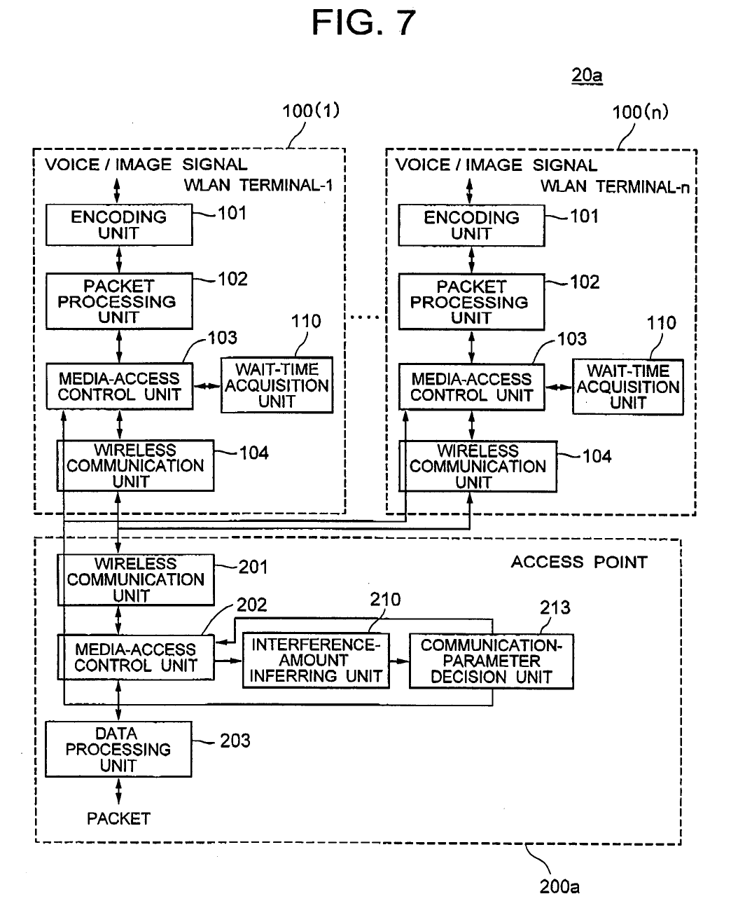

FIG. 7 shows the configuration of a wireless communication system in which the inference-amount inferring unit of the present embodiment is installed. The difference of the wireless communication system 20a and the wireless communication system 20 in the first embodiment shown in FIG. 3 is that the access point 200a in the present embodiment includes the communication-parameter decision unit 213 wherein the communication-parameter decision unit 213 decides the communication parameters for the media access controllers 103 and 202 corresponding to the communication controller 214 of FIG. 5.

The communication-parameter decision unit 213 decides the communication parameters based on the amount of interference inferred by the interference-amount inferring unit 210. For example, if the amount of interference exceeds a threshold value, the media access scheme in the media access controllers 103 and 202 is switched to PCF (Point Coordination Function), or an IFS (Inter Frame Space) and the size of contention window in the wireless LAN system is reduced whereby the priority of data transmission is set at a higher value.

The communication parameters decided by the communication-parameter decision unit 213 are delivered to the media access controller 202 in the access point 200a and the media access controller 103 in the WLAN terminal 100. The media access controllers 103 and 202 switch the current communication parameters to the communication parameters thus decided, thereby switching the communication parameters used between the WLAN terminal 100 and the access point 200a.

In the present embodiment, the amount of interference by the exposing terminal is inferred based on the wait-time information, and the communication parameters are set in consideration of this amount of interference. If there is a terminal receiving the interference caused by the influence of the exposing terminal, the communication-parameter decision unit 213 changes the communication parameters so that the channel acquisition by the “exposed terminal” is given priority, and thereby, a sufficient channel access opportunity can be provided to the “exposed terminal”. Accordingly, the “exposed terminal” is capable of sufficiently frequently sending own packets, and the communication quality of the “exposed terminal” can be maintained.

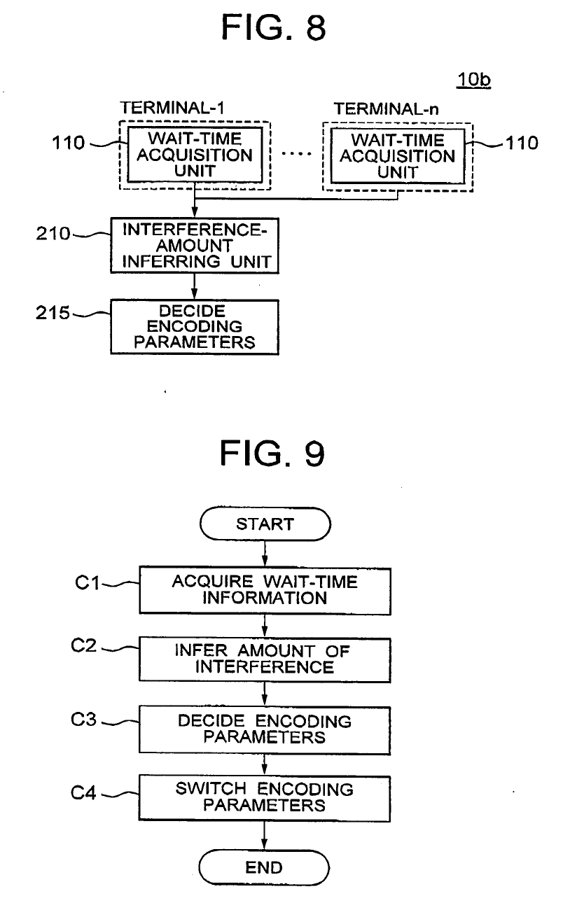

FIG. 8 shows the configuration of a communication controller including an inference-amount inferring unit according to a third embodiment of the present invention. The communication controller 10b in this embodiment has an encoding-parameter decision unit 215, as the means for preventing deterioration of the communication quality. The encoding-parameter decision unit 215 decides the encoding parameters for use in generating transmission data in the own terminal. The encoding parameters include, for example, information compression rate of voice data or image data, and a packet generating interval. The encoding-parameter decision unit 215 decides the encoding parameter so as to enhance the communication efficiency based on the amount of interference inferred by the interference-amount inferring unit 210.

FIG. 9 shows the procedure of a communication controller 10b.

The wait-time acquisition unit 110 acquires wait-time information in a procedure similar to step A1 of FIG. 2 (step C1). Subsequently, the interference-amount inferring unit 210 infers the amount of interference in a procedure similar to step A2 (step C2). The encoding-parameter decision unit 215 determines whether or not there is an “exposed terminal” based on the amount of interference inferred in step C2, and decides encoding parameters so as to enhance the communication efficiency based on the exposed state, i.e., the state of occurring of the interference (step C3). If the encoding parameters are changed by the encoding-parameter decision unit 215, the terminal switches the encoding parameters, and continues the communication (step C4).

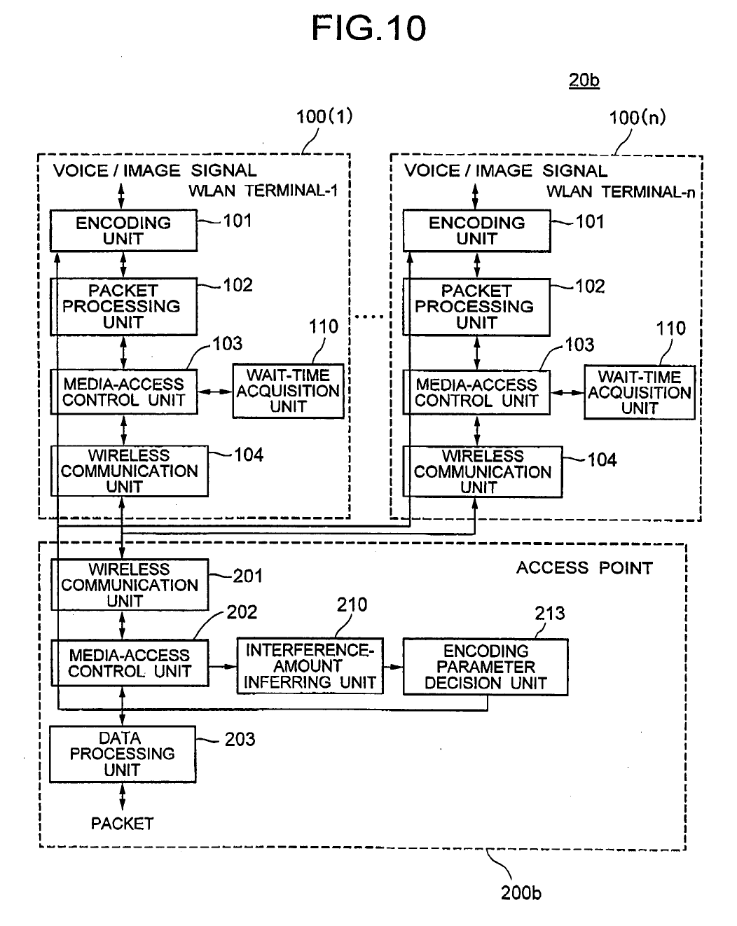

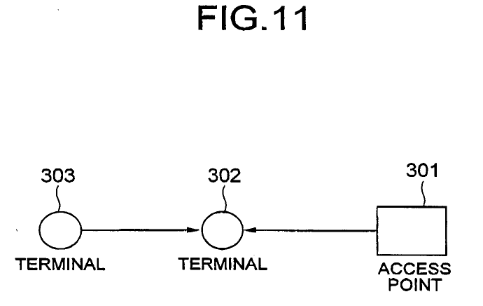

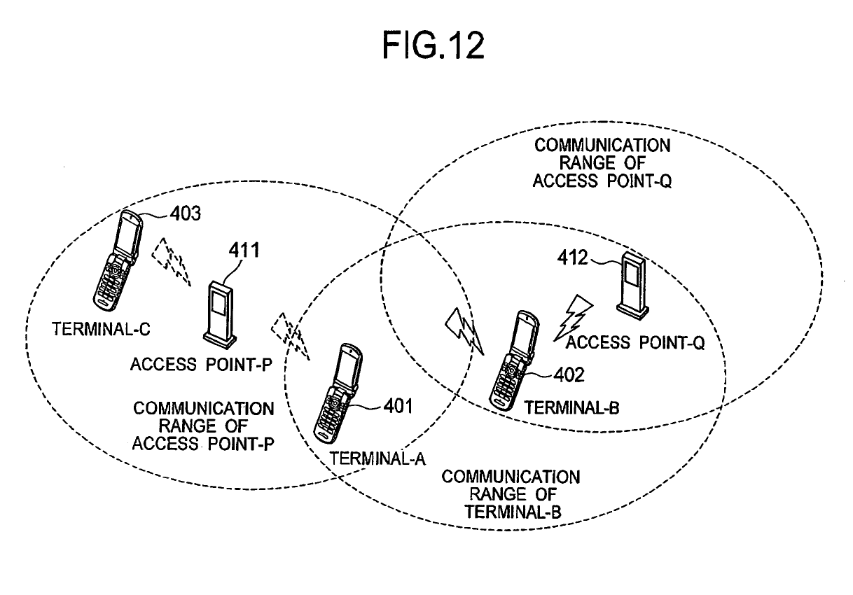

FIG. 10 shows the configuration of a wireless communication system in which an inference-amount inferring unit according to this embodiment is installed. The difference between the wireless communication system 20b and the wireless communication system 20 in the first embodiment shown in FIG. 3 is that the encoding parameters of the encoding unit 101 in the WLAN terminal 100 of the present embodiment is decided by the encoding-parameter decision unit 215 in the access point 200b. In the encoding-parameter decision unit 215, the encoding parameters are decided based on the inferred amount of interference. For example, if the amount of interference exceeds a threshold value, the data volume per one packet is increased by increasing the packetizing period of the “exposed terminal” to reduce the number of packets, and the number of channel acquisition times is reduced. In an alternative, the compression rate of the WLAN terminal 100 except the “exposed terminal” during the encoding is enhanced to increase the channel vacation of the channel. The decided parameters are transmitted to the encoding unit 101, and the encoding parameters for generating the transmission data are switched in the WLAN terminal 100.

In the present embodiment, the amount of interference caused by the exposing terminal is inferred based on the wait-time information, and the encoding parameters are set in consideration of the amount of interference thus inferred. If there is any exposed terminal which receives the interference due to the influence by the exposing terminal, the encoding-parameter decision unit 215 changes the encoding parameters of the “exposed terminal” to enhance the communication efficiency thereof, or changes the encoding parameters except for the exposed terminal to facilitate the channel acquisition by the “exposed terminal”. By using such a principle, the “exposed terminal” can sufficiently forward the packet, and the communication quality of the “exposed terminal” can be maintained.

It is to be noted that the above embodiments may be combined together. For example, while the call admission control is performed based on the channel utilization in consideration of the amount of interference as in the first embodiment, the communication parameters may be set based on the amount of interference as e in the second embodiment. Further, it has been described in the above embodiments that the deterioration of the communication quality is prevented by the means for preventing the communication quality deterioration based on the thus inferred amount of interference. However, if there exists another method for inferring the amount of interference by the exposing terminal, the deterioration of the communication quality may be prevented by the means for preventing the communication quality deterioration, based on the amount of interference inferred by the another method.

The present invention has been described based on the preferred embodiments. However, the apparatus and the method for inferring the amount of interference, the wireless communication system, and the control method thereof of the present invention are not limited to the above embodiments. Various modifications and alterations of the above embodiments may be made without departing from the scope of the present invention.

The present invention can be used for a variety of applications, such as a telephone service for transmitting real time data by utilizing wireless communication system and a streaming service.

What is claimed is:

1. An interference-amount inferring device comprising:
an inferring unit for inferring an amount of interference caused in an exposed wireless communication terminal by an exposing wireless communication terminal, said inferring unit collecting wait-time information representing a degree of wait before transmission of intended data in said exposed wireless communication terminal and inferring said amount of interference based on said collected wait-time information.

2. The interference-amount inferring device according to claim 1, wherein said wait-time information includes at least one of a channel acquisition delay time and a number of back-off stop times before transmission of intended data.

3. The interference-amount inferring device according to claim 2, further comprising a wait-time acquisition unit for measuring said at least one of the channel acquisition delay time and the number of back-off stop times.

4. The interference-amount inferring device according to claim 1, wherein said inferring unit stores therein a relationship between an amount of channel utilization and wait-time information, and infers said amount of interference based on said collected wait-time information and an expected value of said wait-time information in an unexposed wireless communication terminal while referring to said relationship.

5. The interference-amount inferring device according to claim 4, wherein said expected value of said wait time information is collected by a wireless communication terminal not exposed by another wireless communication terminal.

6. The interference-amount inferring device according to claim 4, wherein said inferring unit infers said amount of interference from a difference between an amount of channel utilization corresponding to said collected wait-time information and an amount of channel utilization corresponding to said expected value.

7. The interference-amount inferring device according to claim 1, wherein said inferring unit stores therein a relationship between an amount of channel utilization and wait-time information, and infers said amount of interference based on said collected wait-time information and a current amount of channel utilization while referring to said relationship.

8. The inference-amount inferring device according to claim 7, wherein said inferring unit infers said amount of interference from a difference between said collected wait-time information and said current amount of channel utilization.

9. A wireless communication system comprising:
an interference-amount inferring device for inferring an amount of interference caused in an exposed wireless communication terminal by an exposing wireless communication terminal; and
a communication controller for preventing deterioration of a communication quality in said wireless communication system based on said inferred amount of interference.

10. The wireless communication system according to claim 9, wherein said interference-amount inferring device includes an inferring unit for collecting wait-time information representing a degree of wait before transmission of intended data in said exposed wireless communication terminal and inferring said amount of interference based on said collected wait-time information.

11. The wireless communication system according to claim 9, wherein said communication controller includes a call admission controller for controlling call admission based on said inferred amount of interference.

12. The wireless communication system according to claim 11, wherein said communication controller includes a channel-utilization calculation unit for calculating a current amount of channel utilization based on said inferred amount of interference and a current channel utilization, and executes a call admission control based on said current amount of channel utilization.

13. The wireless communication system according to claim 9, wherein said communication controller includes a communication-parameter decision unit for deciding at least one communication parameter based on said inferred amount of interference.

14. The wireless communication system according to claim 13, wherein said at least one communication parameter includes media-access scheme and/or communication priority of said exposed wireless communication terminal.

15. The wireless communication system according to claim 9, wherein said communication controller includes an encoding-parameter decision unit for deciding at least one encoding parameter based on said inferred amount of interference.

16. The wireless communication system according to claim 15, wherein said encoding parameter includes a compression rate in encoding of transmission data and/or a packet interval.

17. A method for inferring an amount of interference in a wireless communication system, comprising:
collecting wait-time information representing a degree of wait before transmission of intended data in an exposed wireless communication terminal; and
inferring based on said collected wait-time information an amount of interference caused in said exposed wireless communication terminal by an exposing wireless communication terminal.

18. A method for controlling a wireless communication system, comprising:
inferring an amount of interference caused in an exposed wireless communication terminal by an exposing wireless communication terminal; and
preventing deterioration of a communication quality in said wireless communication system based on said inferred amount of interference.

19. The method according to claim 18, wherein said inferring of amount of interference includes: collecting wait-time information representing a degree of wait before transmission of intended data in said exposed wireless communication terminal; and inferring based on said collected wait-time information an amount of interference caused in said exposed wireless communication terminal by said exposing wireless communication terminal.
